(19) United States
(12) Patent Application Publication
(10) Pub. No.: US 2004/0266438 A1
(43) Pub. Date: Dec. 30, 2004

(54) Methods involving a core network node that is handling a mobile subscriber and initiates a request to a second core network node to handle said mobile subscriber

(76) Inventors: Frode Bjelland, Kopervik (NO); Vidar Oliver Lilleheim, Fevik (NO)

Correspondence Address: ERICSSON INC., 6300 LEGACY DRIVE, M/S EVR C11, PLANO, TX, 75024, US

(21) Appl. No.: 10/485,918

(22) PCT Filed: Aug. 6, 2002
(86) PCT No.: PCT/NO02/00275

(30) Foreign Application Priority Data
Aug. 21, 2001 (NO) 20014064

(51) Int. Cl. H04Q 7/20

(52) U.S. Cl. 455/437; 455/436

(57) ABSTRACT

A method is described for handling a mobile station in a mobile telecommunication network where a Radio Access Network (RAN) node is connected to several Core network (CN) nodes. The method proposes that a core network node can send, i.e. initiate, a request of handling a mobile subscriber to another core network node in a mobile telephony network. The decision to request the handover is done in the CN node, and this decision is not done due to the MS or a RAN node determining that a handover is required (which is the normal case). For example, a CN node receiving an initial request (e.g. Attach Request) from a Mobile Subscriber (MS) will, after discovering that it should not or could not handle the request (e.g. due to the user having a subscription by another operator), forward a request to another CN node, one of the correct PLMN. This CN node will then handle the request from the MS.

### FIELD OF THE INVENTION

The present invention relates to mobile telecommunication systems, and in particular to a method for handling a mobile station in a mobile telecommunication network where a Radio Access Network (RAN) node is connected to several Core network (CN) nodes. The CN nodes are placed in the same domain and cover the same geographical area. This opens up for the possibility of several operators to share the radio network, while still having separate CN nodes. This will for example give access for operators which have a 2^{nd} generation network, but who did not receive licenses for a 3^{rd} generation network.

However, in a domain where a RAN node is connected to several CN nodes, and especially in a domain shared by several operators, it is foreseen that several situations can occur which can cause problems. Such situations can be:

A radio network node routes an initial request (e.g. an Attach Request) to a core network node of a wrong PLMN (Public Land Mobile Network) for a certain MS when several operators share the radio network.

A fault occurs in a core network node or on one of the links towards a core network node.

Operation and maintenance work is required on a core network node or on one of the links towards a core network node.

Upgrade of a core network node is required.

Traffic should be moved from one core network node to another core network node due to e.g. unbalanced load between the core network nodes.

### BRIEF DESCRIPTIONS OF THE INVENTION

An object of the present invention is to provide a method for handling a MS in a domain where a RAN node is connected to several CN nodes, and especially in a domain shared by several operators, that avoids the problems mentioned above.

More specific, it is an object of the invention to enable two or more operators share the RAN while having separate CN nodes without impacting the ongoing sessions for an MS which has a subscription at one of the operators, when this MS enters the shared RAN area.

Another object is to enable a (close to) seamless handover of MS data and sessions from one CN node to another when one CN node cannot or should not be reached for an MS or a is group of MSs. This means that the solution gives a higher in service performance for the network.

In brief, the method proposes that a core network node can send, i.e. initiate, a request of handling a mobile subscriber to another core network node in a mobile telephony network. The decision to request the handover is done in the CN node, and this decision is not done due to the MS or a RAN node determining that a handover is required (which is the normal case). For example, a CN node receiving an initial request (e.g. Attach Request) from a Mobile Subscriber (MS) will, after discovering that it should not or could not handle the request, forward a request to another CN node, one of the correct PLMN. This CN node will then handle the request from the MS.

The proposed sequences apply especially in a network configuration where a radio network node is connected to more than one core network node of the same domain. However, the sequences can also be applied in a network where a radio network node is only connected to one core network node of a domain (i.e. the domain comprise several CN nodes, but this particular RAN node is connected to only one of them).

The scope of the invention is as defined in the appended patent claims.

### BRIEF DESCRIPTION OF THE DRAWINGS

The invention will now be described in detail in reference to the appended drawing, in which:

FIG. 1 is a block diagram describing the relationship between RNC/BSC and SGSN/MSC in 3GPP release 4

FIG. 2 shows the relationship between RNC/BSC and SGSN/MSC according to the new pool concept

FIG. 3 is a sequence diagram showing a situation where BSC/RNC is unable to route an initial request from an MS to an SGSN of the correct PLMN

FIG. 4 shows a general sequence according to the present invention for changing core network node, in which SGSN 1 requests SGSN 2 to handle an initial request from an MS

FIG. 5 shows a sequence diagram in which SGSN 1 requests SGSN 2 to handle an Attach Request from an MS

FIG. 6 shows a sequence diagram in which SGSN 1 requests SGSN 2 to handle a Routing Area Update Request from an MS

FIG. 7 shows a sequence diagram in which SGSN 1 requests SGSN 2 to handle a SRNS Relocation procedure for an MS

FIG. 8 shows a sequence diagram in which SGSN 1 in a more or less spontaneous way requests SGSN 2 to handle an MS, i.e. the request sent from SGSN 1 is not sent due to an initial request from the MS.

FIG. 9 shows a sequence diagram for a handover of UMTS GPRS MS in state PMM-connected

### DETAILED DESCRIPTION OF THE INVENTION

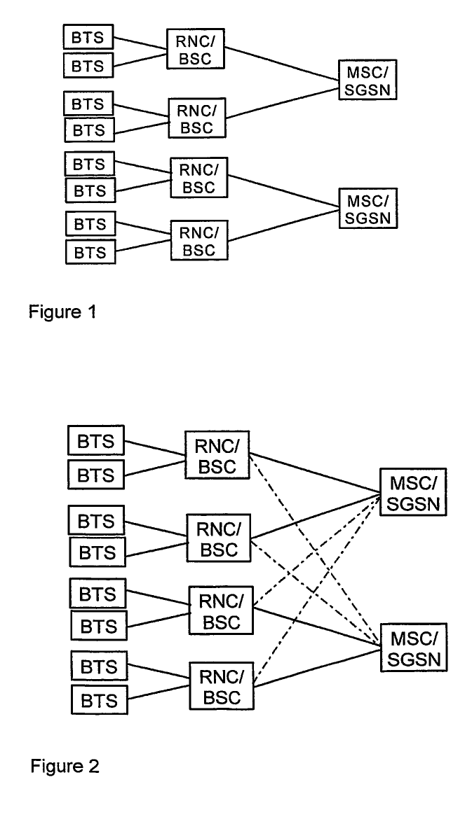

Until now, a radio network node is connected towards one and only one core network node in a certain domain, as shown in FIG. 1. A radio network node is either an RNC (Radio Network Controller) or a BSC (Base Station Controller). A core network node is an SGSN (Serving General Packet Radio Service Support Node) when it is located in the packet switched domain, and it is an MSC (Mobile Services Switching Centre) when it is located in the circuit switched domain. Note that an RNC or a BSC can be connected to both an MSC and an SGSN, but not to two MSCs or to two SGSNs.

3GPP (3rd Generation Partnership Project), which is a standardisation body, is now looking at a concept where a radio network node can be connected towards several core network nodes of the same domain, as shown in FIG. 2. The idea is to place several core network nodes in a pool, and that all of them cover the same geographical area, which then can be bigger than the area previously covered by a core network node. As long as an MS is located within the pool area, the MS will be attached to the same core network node. This has several advantages, e.g. better load sharing between core network nodes, reduced signalling in the core network, better in service performance, better scalability and easier upgrade of the nodes. Also, it opens up for several operators to share the radio network, or parts of it, while still having separate core network nodes. This is especially useful for operators which have a 2G (2nd Generation) network, but who did not receive licences for a 3G (3rd Generation) network, or vice versa. The sharing of radio network is also useful for operators who want to cut costs.

The dotted lines in FIG. 2 shows what is new with the pool concept, i.e. that an RNC or a BSC can be connected to two or more SGSNs and/or to two or more MSCs.

The complexity related to routing of the information received from the MS (Mobile Subscriber) to the correct core network node increases however, as the RNC or the BSC now has to determine which of the SGSNs or MSCs should receive the information that was sent from the MS. The MS is connected to one of the BTSs (Base Transciever Station).

To enable routing of the signalling messages and the data received from the MSs to the correct core network node, (a part of) a parameter that is assigned to the MS will contain information on which core network node allocated the parameter. This information is then included, when needed, in the information sent from the MS to the core network node. The radio network node uses this (part of a) parameter to tell which core network node the MS is (or should/could be) connected to, and hence routes the information received from the MS to the correct core network node. This parameter will most likely be the temporary identity that identifies the MS uniquely in a node, i.e. the TMSI (Temporary Mobile Subscriber Identity) in the CS (Circuit Switched) domain and the P-TMSI (Packet TMSI) in the PS (Packet Switched) domain.

In GSM (Global System for Mobile Communication) GPRS (General Packet Radio Service) the P-TMSI is used as a base for the TLLI (Temporary Logical Link Identity) parameter. Therefore, the bits in the P-TMSI used to indicate which SGSN allocated the P-TMSI will also be available in the TLLI to identify the same SGSN. Since the TLLI is sent in all data and signalling messages from the MS, the TLLI will be used by the BSC to route the information from the MS to the correct SGSN. Other parameters, e.g. the Routing Area (RA), can also be used in combination with this parameter to decide if the MS has already been connected to an SGSN of this pool area when an initial request is made from the MS, e.g. Routing Area Update Request or Attach Request. The disadvantage of the BSC using the Routing Area is that the BSC then has to open messages of a protocol layer it is not meant to look into.

In UMTS (Universal Mobile Telecommunication System) GPRS the bits of the P-TMSI that tell which SGSN allocated the P-TMSI parameter, are sent in a separate parameter from the MS to the RNC when an initial request (e.g. Attach Request or Routing Area Update Request) is sent from the MS. This parameter is called the Intra Domain NAS Node Selector (IDNNS), and this is used in the RNC to decide which SGSN the MS should be connected to. NAS stands for Non Access Stratum.

Other parameters (e.g. Routing Area) can also be used to decide if the MS has already been connected to an SGSN of this pool area. The disadvantage of the RNC using the Routing Area is that the RNC then has to open messages of a protocol layer it is not meant to look into.

When the RNC receives an initial request, it will establish a signalling link towards an SGSN. Later, signalling messages sent between the RNC and the SGSN will be sent on this link. (Note that this signalling link might be released although the PDP (Packet Data Protocol) contexts in the MS, the SGSN and the GGSN can remain.)

When a PDP context is established in UMTS GPRS, two GTP (GPRS Tunnelling Protocol) tunnels are established between the RNC and the SGSN (one GTP tunnel from the RNC to the SGSN, and one GTP tunnel in the opposite direction). These two GTP tunnels are used to forward payload traffic between the RNC and the SGSN.

In general, the principle in a pool area is that the RNC/BSC can select any core network node within its pool area when an MS enters the pool area and performs an initial request (e.g. Attach Request). If the core network node to which the MS was last connected is located in the current pool area, the RNC/BSC should preferably select the same core network node.

In a network configuration where two or more operators share the radio network but has their own core network nodes, the radio network however cannot select any core network node within its pool area when an MS enters the pool area. If the MS has a subscription from one of the operators sharing the radio network, the radio network node has to select a core network node belonging to the correct operator. The problem is that the radio network node will not in the general case receive any parameter that can identify which PLMN (Public Land Mobile Network) the MS belongs to. The radio network therefore has to select any of the core network nodes by random. This can lead to that a core network node of a wrong PLMN is selected.

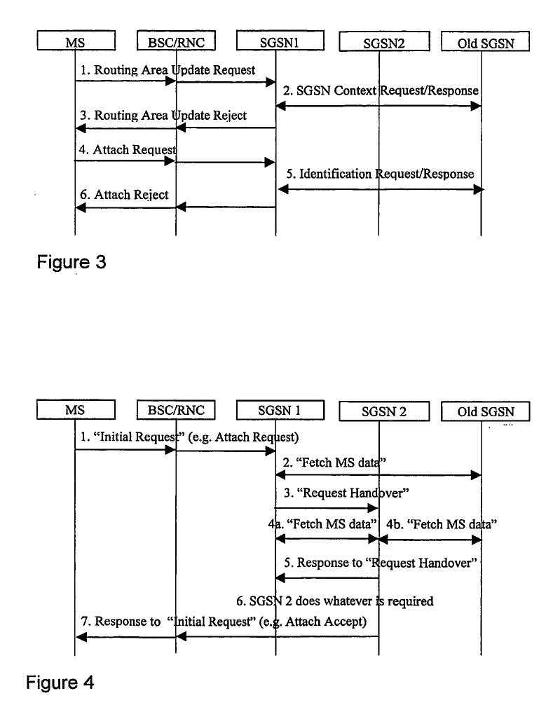

This problem is shown in FIG. 3. Here, the MS has a subscription at operator 2, and operator 2 owns SGSN 2. When entering the pool area where operator 2 shares the radio network with operator 1, the BSC/RNC forwards the initial request to SGSN 1, and SGSN 1 belongs to operator 1. SGSN 1 is not allowed to handle MSs of operator 2, and therefore SGSN 1 will continuously reject the requests from the MS.

In FIG. 3, the MS sends a Routing Area Update Request when entering the new pool. The same will however happen if the MS sends an Attach Request when entering the pool.

In step 1 the MS with a subscription at operator 2 roams into a new area with a pool of two SGSNs. SGSN 1 belongs to operator 1, and SGSN 2 belongs to operator 2. The two operators share the radio network. When the MS sends the Routing Area Update Request, the BSC/RNC uses the TLLI/IDNNS parameter when selecting an SGSN. In the general case, neither of these parameters will indicate to the BSC/RNC which SGSN should handle this MS. Therefore the BSC/RNC forwards the request by random, and the choice happens to be on SGSN 1.

SGSN 1 uses the old RA (and possibly the old P-TMSI) received in the Routing Area Update Request to determine which SGSN the MS previously was attached to. In step 2 SGSN 1 sends an SGSN Context Request message to the old SGSN. The old SGSN uses the old P-TMSI parameter to fetch the MM (Mobility Management) Context data and the PDP (Packet Data Protocol) Contexts of the MS. These are then returned to SGSN 1 in an SGSN Context Response message.

SGSN 1 looks at the received IMSI (International Mobile Subscriber Identity) parameter, and determines that the MS is belongs to the other operator. Since SGSN 1 is not allowed to handle this MS, it sends a Routing Area Update Reject message to the MS. The MS will then still be connected to the old SGSN, i.e. there is no change in the point of attachment from the MS to the old SGSN.

The MS may later repeat step 1 to step 3, but this can again end up with the same result.

When the MS in the end looses the contact towards the radio network of the old SGSN, the MS can send an Attach Request in the new pool area as shown in step 4. When the MS sends the Attach Request, the BSC/RNC uses the TLLI/IDNNS parameter when selecting an SGSN. In the general case, neither of these parameters will indicate to the BSC/RNC which SGSN should handle this MS. Therefore the BSC/RNC forwards the request by random, and the choice happens to be on SGSN 1.

SGSN 1 uses the old RA (and possibly the old P-TMSI) received in the Attach Request to determine which SGSN the MS previously was attached to. In step 5, SGSN 1 sends an Identification Request message to the old SGSN. The old SGSN uses the old P-TMSI parameter to fetch the IMSI (International Mobile Subscriber Identity) and the authentication data of the MS. These are then returned to SGSN 1 in an Identification Response message.

SGSN 1 looks at the received IMSI (International Mobile Subscriber Identity) parameter, and determines that the MS belongs to the other operator. Since SGSN 1 is not allowed to handle this MS, it sends an Attach Reject message to the MS. This is shown in step 6.

The MS could in the end send an Attach Request message using the IMSI parameter to identify itself instead of the P-TMSI parameter. However, the BSC/RNC should not look into the protocol layer where this parameter is sent, and therefore the BSC/RNC will select an SGSN by random again. This can of course again result in that SGSN 1 is selected, and we have the same result.

As can be understood from the above paragraph, the BSC/RNC can determine which SGSN the MS should get connected to when the MS performs an Attach Request with IMSI. An effect of this however, will be that the MS must always detach and attach again before the situation is resolved. The result is therefore that the MS must always abort his ongoing sessions when such a traffic scenario occurs. Therefore this would not be a good solution.

General Sequence for Changing Core Network Node, FIG. 4

Note that some of the steps can be done in another order without influencing the invention.

In step 1 the MS sends an “Initial Request” (e.g. an Attach Request). The BSC/RNC uses the TLLI/IDNNS parameter when selecting an SGSN. In the general case, neither of these parameters will indicate to the BSC/RNC which SGSN should handle this MS. Therefore the BSC/RNC forwards the request by random, and the choice happens to be SGSN 1.

SGSN 1 uses the old RA (and possibly the old P-TMSI) received in the “Initial Request” to determine which SGSN the MS previously was attached to, the old SGSN. In step 2, SGSN 1 requests the MS data from the old SGSN. The old SGSN uses the old P-TMSI parameter to find the data of the MS, e.g. the MM (Mobility Management) Context data (and the PDP Context data if relevant). These are then returned to SGSN 1.

SGSN 1 looks at one of the fixed parameters for the MS, preferably the received IMSI (International Mobile Subscriber Identity) parameter, and determines that the MS belongs to another operator of this pool. SGSN 1 can here include a new analysis on a parameter that is fixed for the MS, preferably on the IMSI, to determine which other SGSN should handle this MS. Alternatively, SGSN 1 can have it configured by Operation and Maintenance which other SGSN should handle this MS, i.e. by having configured one or more default SGSN to contact. Since SGSN 1 is not allowed to handle this MS, it sends a “Request Handover” message to a SGSN of the correct operator, SGSN 2. This is shown in step 3. This message should preferably contain information on which CN node sent the message, and which RAN node the “Initial Request” was received from, as well as a parameter that is fixed for the MS, preferably the IMSI and/or the old P-TMSI together with the old RA (old P-TMSI and old RA is not fixed for the MS). Also the address of the old SGSN can be included. This message could also contain the MS data (in case the MS data is included, step 4a and step 4b are omitted), but preferably it should not. The complete “Initial Request” message should preferably be forwarded from SGSN 1 to SGSN 2, either in a separate message or included in the “Request Handover” message. Alternatively, only the required parameters are sent over to SGSN 2 in this “Request Handover” message or in another new message.

In step 4, SGSN 2 receives or requests the MS data. This is either fetched from SGSN 1 as shown in step 4a, or it is fetched from the old SGSN as shown in step 4b. If step 4b is done and the “Initial Request” is a Routing Area Update Request, SGSN 1 should preferably indicate to the old SGSN that the transfer of the MS from the old SGSN to SGSN 1 was unsuccessful, when this is possible and applicable. This indication should preferably be sent, from SGSN 1 to the old SGSN, before SGSN 1 sends the “Request Handover” message to SGSN 2.

In step 5, which is optional, SGSN 2 informs SGSN 1 that SGSN 2 will handle the MS. SGSN 1 will then clean up the resources temporarily used to handle this MS.

In step 6, SGSN 2 sets up, signals, or fetches whatever is required. In UMTS GPRS this will at least include setting up a signalling connection over the Iu interface, i.e. between SGSN 2 and the RNC.

In step 7, SGSN 2 will inform the MS that the “Initial Request” was successful. In this message SGSN 2 will normally allocate a new P-TMSI value to the MS, so that the next messages from the MS will be sent to the correct SGSN, SGSN 2.

Method for How the New SGSN (SGSN 2) Shall Identify Which RAN Node Forwarded the “Initial Request” to the First SGSN (SGSN 1)

In FIG. 4, SGSN 2 must know which RAN node to contact when setting up the signalling connection in UMTS, and when sending the response on the “Initial Request” to the MS. The proposed solutions are different in GSM GPRS and in UMTS, as different kind of data is available.

In UMTS, SGSN 1 should preferably send the ‘Global RNC-ID’ (Radio Network Controller Identifier) to SGSN 2. Alternatively, SGSN 1 could send the ‘LAI’ (Location Area Identity) and the ‘RAC’ (Routing Area Code). Yet another alternative is that SGSN 1 sends the ‘SAI’ (Service Area Identifier). SGSN 2 can use either of these parameters or a combination of them to determine which RAN node to contact.

In GSM GPRS, SGSN 1 should preferably send the ‘Cell Identifier’ to SGSN 2. Alternatively, SGSN 1 could send the ‘BVCI’ (BSSGP Virtual Connection Identifier, where BSSGP stands for BSS GPRS Protocol, and here BSS stands for Base Station System, and GPRS stands for General Packet Radio Service) and/or the ‘NSEI’ (Network Service Equipment Identifier). Since the NSEI is a 2 octets string and not a globally unique identifier, this parameter should preferably be structured in a new way when the operator configures the path between the RAN node and the SGSN. One part of the NSEI should identify the SGSN and another part of the NSEI should identify the RAN node. In this way, SGSN 2 can immediately say which RAN node the “Initial Request” was sent through. SGSN 2 can use either of these parameters or a combination of them to determine which RAN node to contact.

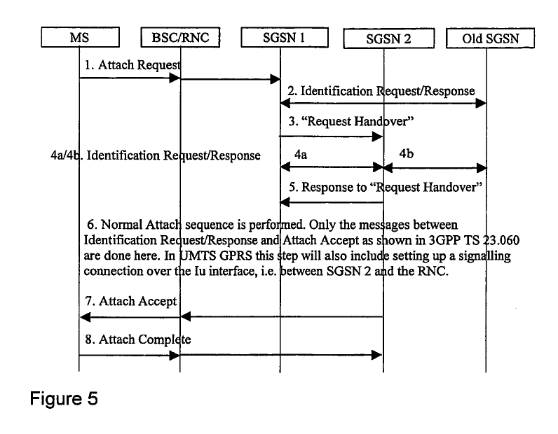

Sequence for the Attach Procedure, FIG. 5

Note that some of the steps can be done in another order without influencing the invention.

In step 1 the MS sends an Attach Request. The BSC/RNC uses the TLLI/IDNNS parameter when selecting an SGSN. In the general case, neither of these parameters will indicate to the BSC/RNC which SGSN should handle this MS. Therefore the BSC/RNC forwards the request by random, and the choice happens to be SGSN 1.

SGSN 1 uses the old RA (and possibly the old P-TMSI) received in the “Initial Request” to determine which SGSN the MS previously was attached to, the old SGSN. In step 2, SGSN 1 requests the MS data from the old SGSN. The old SGSN uses the old P-TMSI parameter to find the data of the MS. The IMSI and the authentication data are then returned to SGSN 1 in an Identification Response message.

SGSN 1 looks at one of the fixed parameters for the MS, preferably the received IMSI (International Mobile Subscriber Identity) parameter, and determines that the MS belongs to another operator of this pool. SGSN 1 can here include a new analysis on a parameter that is fixed for the MS, preferably on the IMSI, to determine which SGSN should handle this MS. Alternatively, SGSN 1 can have it configured by Operation and Maintenance which other SGSN should handle this MS, i.e. by having configured one or more default SGSN to contact. Since SGSN 1 is not allowed to handle this MS, it sends a “Request Handover” message to a SGSN of the correct operator, SGSN 2. This is shown in step 3. This message should preferably contain information on which CN node sent the message, and which RAN node the “Initial Request” was received from, as well as a parameter that is fixed for the MS, preferably the IMSI and/or the old P-TMSI together with the old RA. Also the address of the old SGSN can be included. This message could also contain the MS data (in case the MS data is included, step 4a and step 4b are omitted), but preferably it should not. The complete Attach Request message should preferably be forwarded from SGSN 1 to SGSN 2, either in a separate message or included in the “Request Handover” message. Alternatively, only the required parameters are sent over to SGSN 2 in this “Request Handover” message or in another new message.

In step 4, SGSN 2 requests the MS data. This is either fetched from SGSN 1 as shown in step 4a, or it is fetched from the old SGSN as shown in step 4b.

In step 5, which is optional, SGSN 2 informs SGSN 1 that SGSN 2 will handle the MS. SGSN 1 will then clean up the resources temporarily used to handle this MS.

In step 6, a normal Attach sequence is performed. Only the messages between Identification Request/Response and Attach Accept as shown in 3GPP TS 23.060 are done here. In UMTS GPRS this step will also include setting up a signalling connection over the Iu interface, i.e. between SGSN 2 and the RNC.

In step 7, SGSN 2 will inform the MS that the Attach procedure was successful. In this message SGSN 2 will normally allocate a new P-TMSI value to the MS, so that the next messages from the MS will be sent to the correct SGSN, SGSN 2.

In step 8, the MS sends an Attach Complete message to SGSN 2.

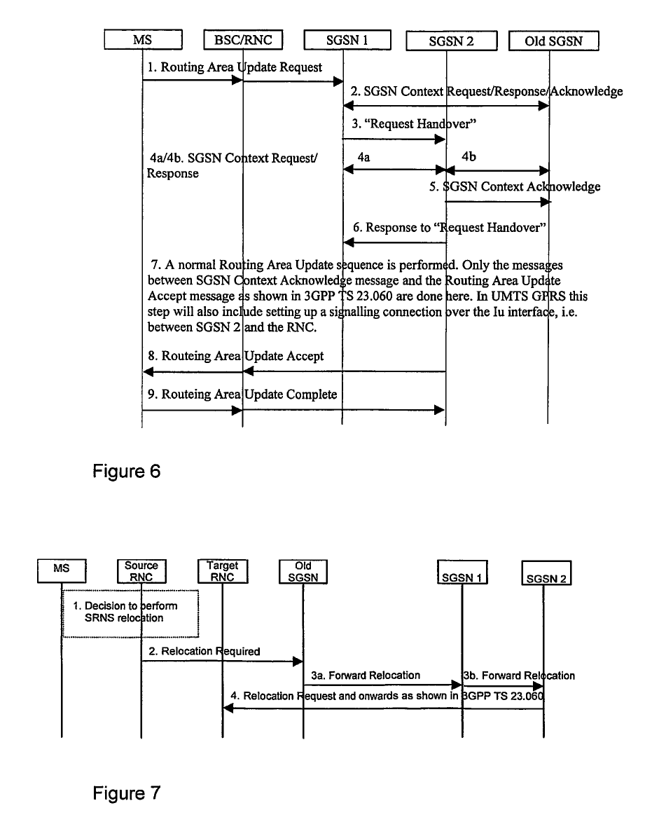

Sequence for the Routing Area Update Procedure, FIG. 6

Note that some of the steps can be done in another order without influencing the invention.

In step 1 the MS sends a Routing Area Update Request. The BSC/RNC uses the TLLI/IDNNS parameter when selecting an SGSN. In the general case, neither of these parameters will indicate to the BSC/RNC which SGSN should handle this MS.

Therefore the BSC/RNC forwards the request by random, and the choice happens to be SGSN 1.

SGSN 1 uses the old RA (and possibly the old P-TMSI) received in the “Initial Request” to determine which SGSN the MS previously was attached to, the old SGSN. In step 2, SGSN 1 requests the MS data from the old SGSN. The old SGSN uses the old P-TMSI parameter to find the MM (Mobility Management) Context data (and the PDP (Packet Data Protocol) Context data if relevant) of the MS. These are then returned to SGSN 1 in an SGSN Context Response message. SGSN 1 looks at one of the fixed parameters for the MS, preferably the received IMSI (International Mobile Subscriber Identity) parameter, and determines that the MS belongs to another operator of this pool. SGSN 1 can then optionally send an SGSN Context Acknowledge message to the old SGSN and indicate that the transfer of the MS was unsuccessful. If this is done, step 4b is done instead of step 4a.

SGSN 1 can include a new analysis on a parameter that is fixed for the MS, preferably on the IMSI, to determine which SGSN should handle this MS. Alternatively, SGSN 1 can have it configured by Operation and Maintenance which other SGSN should handle this MS, i.e. by having configured one or more default SGSN to contact. Since SGSN 1 is not allowed to handle this MS, it sends a “Request Handover” message to a SGSN of the correct operator, SGSN 2. This is shown in step 3. This message should preferably contain information on which CN node sent the message, and which RAN node the Routing Area Update Request message was received from, as well as a parameter that is fixed for the MS, preferably the IMSI and/or the old P-TMSI together with the old RA. Also the address of the old SGSN can be included. This message could also contain the MS data (in case the MS data is included, step 4a and step 4b are omitted), but preferably it should not. The complete Routing Area Update Request message should preferably be forwarded from SGSN 1 to SGSN 2, either in a separate message or included in the “Request Handover” message. Alternatively, only the required parameters are sent over to SGSN 2 in this “Request Handover” message or in another new message.

In step 4, SGSN 2 requests the MS data. This is either fetched from SGSN 1 as shown in step 4a, or it is fetched from the old SGSN as shown in step 4b. If step 4b is done, SGSN 1 should preferably indicate, by sending the SGSN Context Acknowledge message, to the old SGSN that the transfer of the MS from the old SGSN to SGSN 1 was unsuccessful in step 2.

In step 5, SGSN 2 sends an SGSN Context Acknowledge message to the old SGSN. In GSM GPRS this informs the old SGSN that SGSN 2 is ready to receive data packets belonging to the activated PDP contexts.

In step 6, SGSN 2 informs SGSN 1 that SGSN 2 will handle the MS. SGSN 1 will then clean up the resources temporarily used to handle this MS.

In step 7, a normal Routing Area Update sequence is performed. Only the messages between SGSN Context Acknowledge message and the Routing Area Update Accept message as shown in 3GPP TS 23.060 are done here. In UMTS GPRS this step will also include setting up a signalling connection over the Iu interface, i.e. between SGSN 2 and the RNC.

In step 8, SGSN 2 will inform the MS that the Routeing Area Update procedure was successful. In this message SGSN 2 will normally allocate a new P-TMSI value to the MS, so that the next messages from the MS will be sent to the correct SGSN, SGSN 2.

In step 9, the MS sends a Routeing Area Update Complete message to SGSN 2.

Sequence for the SRNS Relocation Procedure, FIG. 7

The source or serving RNC decides to perform/initiate an SRNS (Serving Radio Network Subsystem) relocation, as shown in 3GPP TS 23.060.

2) The source RNC initiates the relocation preparation procedure by sending a Relocation Required to the old SGSN, as shown in 3GPP TS 23.060.

3a) The old SGSN initiates the relocation resource allocation procedure by sending a Forward Relocation Request message to SGSN 1, as shown in 3GPP TS 23.060.

3b) SGSN 1 looks at one of the fixed parameters for the MS, preferably the received IMSI (International Mobile Subscriber Identity) parameter, and determines that the MS belongs to another operator of this pool. SGSN 1 can here include a new analysis on a parameter that is fixed for the MS, preferably on the IMSI, to determine which SGSN should handle this MS. Alternatively, SGSN 1 can have it configured by Operation and Maintenance which other SGSN should handle this MS, i.e. by having configured one or more default SGSN of other PLMN(s) to contact. Since SGSN 1 is not allowed to handle this MS, it forwards the Forward Relocation Request message to a SGSN of the correct operator, SGSN 2.

This step is new. It is already discussed within 3GPP that an SGSN can forward this message to a new SGSN, but it is not discussed that an SGSN can have an analysis on the IMSI parameter in order to select a SGSN of the correct PLMN, alternatively to have configured one or more default SGSN of another PLMN to contact.

SGSN 2 sends a Relocation Request message to the target RNC. From this step and onwards, the procedure is as shown in 3GPP TS 23.060.

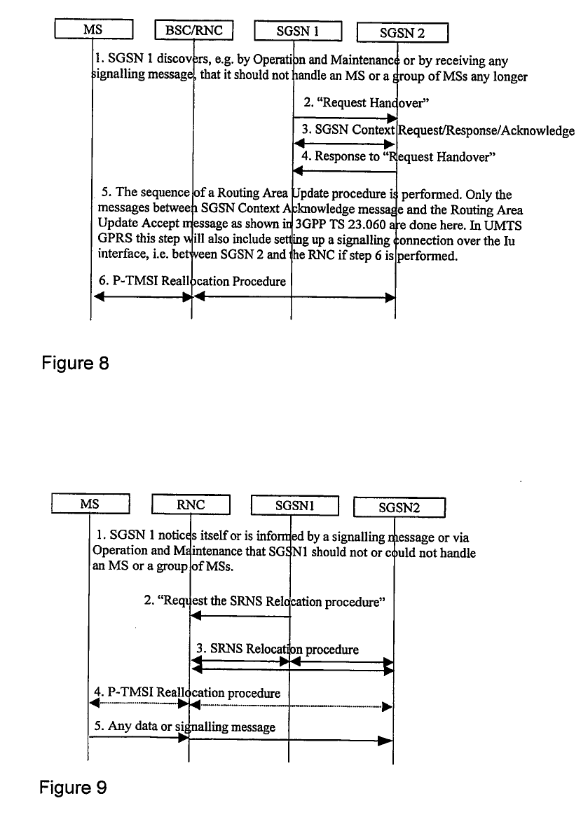

Sequence for Handover of MS Data to a New SGSN, FIG. 8

Note that some of the steps can be done in another order without influencing the invention.

This sequence is preferred for a GSM GPRS MS, or for a UMTS GPRS MS in mobility state PMM-idle (Packet Mobility Management), but can also be used for a UMTS GPRS MS in mobility state PMM-connected.

In step 1, SGSN 1 discovers, e.g. by Operation and Maintenance or by receiving any signalling message or by some internal happening, that it cannot or should not handle an MS or a group of MSs any longer.

In step 2, SGSN 1 sends a “Request Handover” message to another SGSN, SGSN 2. This message should preferably contain information on which CN node sent the message, and which RAN node is used for the MS, as well as a parameter that is fixed for the MS, preferably the IMSI and/or the old P-TMSI together with the old RA. This message could also contain the MS data (in case the MS data is included, step 3 is omitted), but preferably it should not.

In step 3, SGSN 2 requests the MS data from SGSN 1. If the MS has activated any PDP contexts, SGSN 2 sends an SGSN Context Acknowledge message to SGSN 1. In GSM GPRS this informs the old SGSN that SGSN 2 is ready to receive data is packets belonging to the activated PDP contexts.

In step 4, which is optional, SGSN 2 informs SGSN 1 that SGSN 2 will handle the MS. SGSN 1 will then clean up the resources temporarily used to handle this MS.

In step 5, the sequence of a Routing Area Update procedure is performed. Only the messages between SGSN Context Acknowledge message and the Routing Area Update Accept message as shown in 3GPP TS 23.060 are done here. In UMTS GPRS this step will also include setting up a signalling connection over the Iu interface, i.e. between SGSN 2 and the RNC if step 6 is performed.

Step 6 is optional and it is only performed in case SGSN 2 should allocate a new P-TMSI value to the MS.

Sequence for Handover of UMTS GPRS MS, FIG. 9

This sequence is preferred for a UMTS GPRS MS in mobility state PMM-connected.

In step 1, SGSN 1 notices itself or is informed by a signalling message or via Operation and Maintenance that SGSN 1 should not or could not handle an MS or a group of MSs.

In step 2, SGSN 1 requests the source RNC to perform an SRNS Relocation procedure.

In step 3, the source RNC initiates the SRNS Relocation procedure (as described in 3GPP TS 23.060) for the indicated MS. This means that the MM contexts and the PDP contexts for the MSs are moved from SGSN 1 to SGSN 2. This procedure can be performed with and without MS involvement, but here it should preferably be done without MS involvement. Also, the existing procedure can be modified slightly so that no messages are sent towards the MS in this case. As stated in the previous sentence, the SRNS Relocation procedure is an existing procedure that here is suggested to be used in a new way. It is also suggested that the target RNC in the Relocation Required message (which is the first message being sent in this procedure, and it is sent from the source RNC to the source SGSN, SGSN 1) should be set equal to the source RNC. In this way the RNC is not changed, only the SGSN. (Today this procedure involves two different RNCs, the source RNC and the target RNC.)

Today the source SGSN (SGSN 1) uses the target RNC or the target ID to decide which SGSN should be the target SGSN (i.e. the new SGSN). When using the SRNS Relocation procedure for this purpose, the RNC could include an additional and new parameter in the Relocation Required message to indicate which SGSN the MS should be attached to after the SRNS Relocation procedure. This could be helpful e.g. in the case where the RNC has the knowledge of the load of the different SGSNs in the pool area. Alternatively, the source SGSN can itself figure out which SGSN should be the target SGSN.

Step 4 is optional, and it is only done to supply a new PTMSI value to the MS. This can e.g. be done with the P-TMSI Reallocation procedure (for simplicity, the whole procedure is not shown here, but it can be found in 3GPP TS 23.060).

In step 5 the RNC routes the next data or signalling message received from the MS to the new SGSN, SGSN 2.

Although the invention in most scenarios describe solutions for a network where two or more operators have separate CN nodes while sharing one or more RAN nodes, this invention is also applicable for the more general case when a radio network node is connected to several core network nodes. Some parts of the invention is even applicable when each of the RAN nodes are only connected to one CN node in a domain.

The invention is applicable for any packet switched mobile telephony system. In particular, one can mention both GSM (Global System for Mobile Communication) and UMTS (Universal Mobile Telecommunication System).

The invention could also be applicable in the circuit switched domain.

In this invention, as described above, a part of the P-TMSI parameter (and therefore also the TLLI parameter in GSM GPRS) is used to identify which core network node the MS should be connected to. Other parameters might be used for this purpose.

1-60. (Cancelled)

61. In a telecommunications network, a method for sharing a Radio Access Network (RAN) by first and second network operators, wherein a plurality of Core Network (CN) nodes associated with said first and second network operators, respectively, are coupled to said RAN, said method comprising the steps of:
receiving an Initial Request (IR) message from a Mobile Station (MS) at said shared RAN;
forwarding said IR message from said RAN to a first one of said plurality of CN nodes;
determining from said IR message which of said first and second network operators said MS is subscribed to; and
if said first one of said plurality of CN nodes to which said IR message was forwarded is not managed by the network operator to which said MS is subscribed, sending a Request Handover (RH) message to a second one of said plurality of CN nodes, said second one of said plurality of CN nodes being managed by the network operator to which said MS is subscribed.

62. The method recited in claim 61, wherein a CN node, in order to determine if the MS can, or should, be handled, is adapted to perform the steps of:
determining the address of the previous CN node to which the MS was connected; and
fetching or receiving MS data from said previous CN node.

63. The method recited in claim 61, further comprising the step of sending a response message to said first one of said plurality of CN nodes rejecting the handover if said second one of said plurality of CN nodes determines that it cannot handle the MS.

64. The method recited in claim 61, wherein a CN node is adapted to detect which operator the MS is subscribed to by performing the step of analyzing a parameter that is fixed for the MS.

65. The method recited in claim 64, wherein said parameter is the International Mobile Subscriber Identity (IMSI) associated with said MS.

66. The method recited in claim 61, wherein said first one of said plurality of CN nodes is adapted to send the “Request Handover” message to a second CN node based on load information of the plurality of CN nodes.

67. The method recited in claim 61, wherein said first one of said plurality of CN nodes is adapted to send the “Request Handover” message to a default second CN node.

68. The method recited in claim 61, wherein said “Request Handover” message comprises the identity of said first one of said plurality of CN nodes.

69. The method recited in claim 61, wherein said “Request Handover” message comprises a parameter that identifies or can be used to identify a RAN node to which the MS last sent a message.

70. The method recited in claim 61, wherein said “Request Handover” message comprises a parameter that identifies or can be used to identify the geographic area in which the MS is currently located.

71. The method recited in claim 61, wherein said first one of said plurality of CN nodes sends a message to said second one of said plurality of CN nodes after said “Request Handover” message is sent, wherein said message comprises a parameter that identifies or can be used to identify said shared RAN node.

72. The method recited in claim 61, wherein said first one of said plurality of CN nodes sends a message to said second one of said plurality of CN nodes after said “Request Handover” message is sent, wherein said message comprises a parameter that identifies or can be used to identify the geographic area in which said MS is currently located.

73. The method recited in claim 61, wherein said first one of said plurality of CN nodes sends a Global Radio Network Controller Identifier to said second one of said plurality of CN nodes to identify said shared RAN node or the geographic area where the MS is currently located.

74. The method recited in claim 61, wherein said first one of said plurality of CN nodes sends a Location Area Identity or Routing Area Code to said second one of said plurality of CN nodes to identify said shared RAN node or the geographic area where the MS is currently located.

75. The method recited in claim 61, wherein said first one of said plurality of CN nodes sends a Service Area Identifier to said second one of said plurality of CN nodes to identify said shared RAN node or the geographic area where the MS is currently located.

76. The method recited in claim 61, wherein said first one of said plurality of CN nodes sends a Cell Identifier to said second one of said plurality of CN nodes to identify said shared RAN node or the geographic area where the MS is currently located.

77. The method recited in claim 61, wherein said IR message comprises an Attach Request message.

78. The method recited in claim 61, wherein said IR message comprises a Routing Area Update Request message.

79. The method recited in claim 61, wherein said IR message comprises a Location Area Update Request message.

80. The method recited in claim 61, wherein said second one of said plurality of CN nodes sends a response message back to said first one of said plurality of CN nodes.

81. The method recited in claim 61, wherein said network comprises a Universal Mobile Telecommunication System (UMTS) network, and wherein said second one of said plurality of CN nodes sets up a signalling connection towards said shared RAN node using a RAN Application Part message.

82. In a telecommunications network, a method for performing a Serving Radio Network Subsystem relocation, wherein said network comprises at least one Radio Access Network (RAN) node and a plurality of Core Network (CN) nodes associated with first and second network operators, said method comprising the steps of:
sending, from a first Radio Access Network (RAN) node to which a Mobile Station (MS) is connected, a Relocation Required message to the current CN node to which the Mobile Station is connected;
sending, from said current CN node, a Forward Relocation Request (FRR) message to a second one of said plurality of CN nodes;
determining from said FRR message which of said first and second network operators said MS is subscribed to; and
if said second one of said plurality of CN nodes to which said FRR message was sent is not managed by the network operator to which said MS is subscribed, forwarding said FRR message to a third one of said plurality of CN nodes, said third one of said plurality of CN nodes being managed by the network operator to which said MS is subscribed.

83. The method recited in claim 82, wherein a CN node is adapted to detect which operator the MS is subscribed to by performing the step of analyzing a parameter that is fixed for the MS.

84. The method recited in claim 83, wherein said parameter is the International Mobile Subscriber Identity (IMSI) associated with said MS.

85. The method recited in claim 82, wherein said first one of said plurality of CN nodes is adapted to send the FRR message to a default second CN node.

86. In a telecommunications network having a plurality of Core Network (CN) nodes associated with first and second network operators, a method for managing the routing of communications of a Mobile Station (MS) through said network, said method comprising the steps of:
receiving a message associated with said MS at a first of said plurality of CN nodes;
determining which of said first and second network operators said MS is subscribed to; and
if said first one of said plurality of CN nodes at which said message was received is not managed by the network operator to which said MS is subscribed, initiating a procedure to handover said MS to a second one of said plurality of CN nodes managed by the network operator to which said MS is subscribed.

87. The method recited in claim 86, wherein said procedure to handover said MS comprises the step of sending a Request Handover (RH) message to a second one of said plurality of CN nodes, said second one of said plurality of CN nodes being managed by the network operator to which said MS is subscribed.

88. The method recited in claim 86, wherein a CN node, in order to determine if the MS can, or should, be handled, is adapted to perform the steps of:
determining the address of the previous CN node to which the MS was connected; and
fetching or receiving MS data from said previous CN node.

89. The method recited in claim 86, wherein a CN node is adapted to detect which operator the MS is subscribed to by performing the step of analyzing a parameter that is fixed for the MS.

90. The method recited in claim 89, wherein said parameter is the International Mobile Subscriber Identity (IMSI) associated with said MS.

91. The method recited in claim 87, wherein said first one of said plurality of CN nodes is adapted to send said “Request Handover” message to a second CN node based on load information of the plurality of CN nodes.

92. The method recited in claim 87, wherein said first one of said plurality of CN nodes is adapted to send said “Request Handover” message to a default second CN node.

93. The method recited in claim 87, wherein said “Request Handover” message comprises the identity of said first one of said plurality of CN nodes.

94. The method recited in claim 87, wherein said “Request Handover” message comprises a parameter that identifies or can be used to identify a Radio Access Network (RAN) node to which the MS last sent a message.

95. The method recited in claim 87, wherein said “Request Handover” message comprises a parameter that identifies or can be used to identify the geographic area in which the MS is currently located.
